(19) United States
(12) Patent Application Publication
(10) Pub. No.: US 2010/0039512 A1
(43) Pub. Date: Feb. 18, 2010

(54) DEVICE FOR TELECOMMUNICATION COMPRISING ALARM DEVICES IN SECURED AREAS

(76) Inventor: Peter Kurz, Essen (DE)

Correspondence Address: K.F. ROSS P.C., 5683 RIVERDALE AVENUE, SUITE 203 BOX 900, BRONX, NY, 10471-0900, US

(21) Appl. No.: 12/443,477

(22) PCT Filed: Oct. 9, 2007
(86) PCT No.: PCT/EP07/08736

§ 371 Date: Mar. 28, 2009

(30) Foreign Application Priority Data
Oct. 14, 2006 (DE) 102006048705.2

(51) Int. Cl. H04N 7/18

(52) U.S. Cl. 348/143; 340/540; 709/223; 348/E07.085

(57) ABSTRACT

A device for telecommunication comprising alarm devices or the like, installed in secured areas (2) such as apartments, vacation or private homes, company buildings, shops, banks, insurances and the like, has a central unit (3), which is associated with an alarm device disposed in a secured area (2) and to which surveillance or sensor units (3) are connected, and an internet portal (7), which is hosted on a server and contacted by the central unit (4) in case warning signals are received from the associated surveillance or sensor units (3). The internet portal allows for communication means (9) to contact a person (1) associated with the respective secured area (2). The internet portal can be accessed by the person (1) with a key or password. In order to allow the person responsible for the secured area (2) to obtain further information regarding the incident reported by the surveillance and sensor unit (3), before initiating emergency or alarm measures, according to the invention the central unit (4) of the alarm device associated with the secured area (2) comprises a hardware key (5) with a CPU having access memory (6), in which a mathematical encryption mechanism is stored and is designed to be not readable. The hardware key (5) can be accessed via the internet portal (7) by separately secured transmission channels. A web server is associated with the hardware key such that optionally further communication means having a browser can be used by a person contacted by the internet portal (7) to gain access to the warning signals of the surveillance- and sensor unit (3) detected in the alarm device associated with the secured area (2) by using the key or password via the internet portal (7).

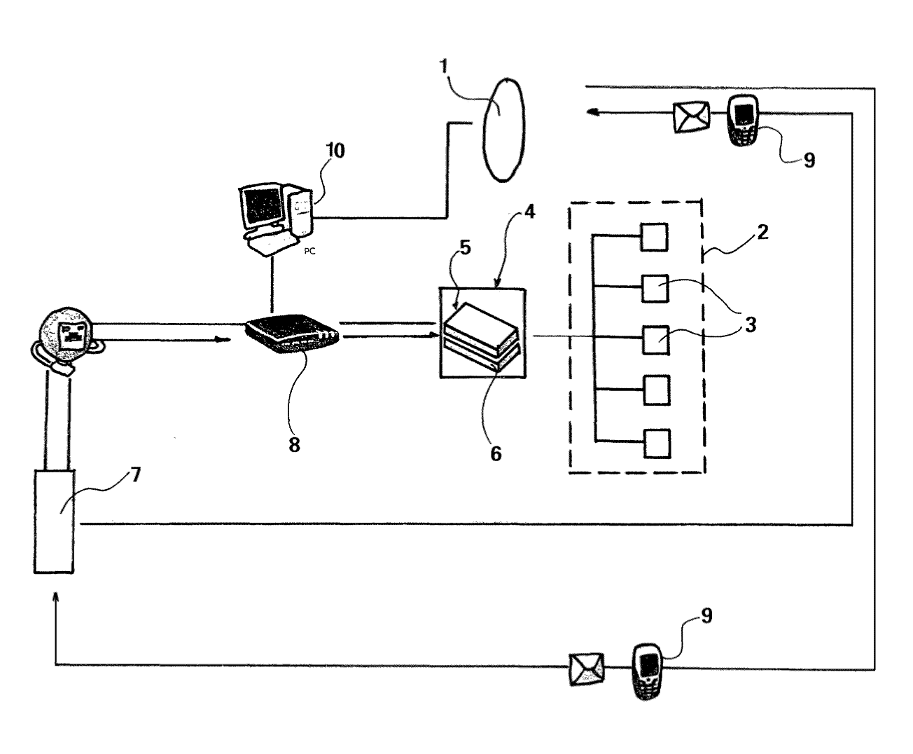

The invention relates to a system for telecommunicating with alarm systems or the like installed in secure areas, such as apartments, vacation homes and private houses, office buildings, business premises, banks, insurance companies, etc., with a central unit that is part of an alarm system provided in a secure area and to which monitoring devices or sensors provided in or at the secure area are connected, and an internet portal, which is hosted on its server and is contacted by the central unit in the event of warning signals from the monitoring devices or sensors assigned thereto, by means of which a communication means of a person assigned to the respective secure area can be contacted and which can be contacted by the contacted person using a key word or password.

With known telecommunication systems of this type usually an alarm signal or emergency signal is triggered, upon which specific measures are directly initiated, e.g., the deployment of a security service at or in the secure area, a corresponding police operation or the like.

The object of the invention is to further develop the generic system for telecommunicating with for telecommunicating with alarm systems or the like such that a person assigned to the secure area, before initiating any emergency or alarm measures, can perform an inspection of signals recorded on the part of the monitoring devices or sensors, wherein an inspection of this type should be possible exclusively by the person assigned to the secure area or responsible for the secure area.

This object is attained according to the invention in that the central unit of the alarm system assigned to the secure area has a hardware key with a CPU with an access memory in which a mathematical encryptor is stored and which is not readable, that the hardware key can be contacted by the internet portal via a dedicated secure transmission channel to which a Web server is assigned so that by an optional further communications means assigned to the person contacted by the internet portal and provided with a browser, using the key word or password via the internet portal access can be gained to the warning signals of the monitoring and sensor devices recorded in the central unit of the alarm system assigned to the secure area.

With such a central unit with hardware key, the use of a hard disk or the use of a Windows system or similar system for communication between the person responsible for the secure area and the central unit can be omitted. Before starting any alarm or emergency measures, the person responsible for the secure area can do an actual inspection to determine whether the data recorded by the monitoring devices or sensors of the alarm system of the secure area actually justify such emergency measures or alarm measures. The person in charge of or responsible for the secure area is automatically notified by the internet portal via a suitable communication means that signals have been detected by the monitoring and sensor devices. Hereupon the contacted person can establish the prerequisites by the password or key word at the internet portal, which can contact the central unit or the hardware key thereof via separately secured transmission channels, that the person responsible for the secure area can access via a further communication means that is equipped with a browser those signals that were detected by the monitoring devices or sensors of the alarm system of the secure area. Before corresponding alarm measures or emergency measures are initiated, the person assigned to the secure area or responsible for the secure area can therefore conduct an inspection to determine whether corresponding alarm measures or emergency measures are necessary at all.

The monitoring devices or sensors connected to the central unit can be for example video cameras and/or contacts—e.g. door and/or window contacts, and/or sound and/or motion detectors. Monitoring devices or sensors of this type can transmit a reliable image of the actual situation with comparatively low expenditure.

The further communication means provided with a browser can advantageously be a PC or the like.

The connection between the central unit provided with the hardware key and the internet portal or the communication means provided with the browser can advantageously be through a DSL modem. A cell phone can also be used as communication means between the internet portal on the one hand and the person responsible for the secure area on the other hand.

The connection from the internet portal to the communication means of the person contacted or to be contacted can be by UMTS, SMS, e-mail or by other transmission channels.

The connection from the communication means of the contacted person to the internet portal can be by SMS, MMS, e-mail or by an internet connection.

The invention is explained in more detail below based on an embodiment with reference to the drawing, in the only FIGURE of which an illustrated embodiment of a system according to the invention for telecommunication with alarm systems or the like installed in secure areas is shown.

An illustrated embodiment of a system according to the invention for telecommunication with alarm systems or the like installed in secure areas, such as apartments, vacation homes and private homes, office buildings, business premises, banks, insurance companies, etc., shown schematically in the only FIGURE, serves among other things to give a person 1 shown in the sole FIGURE and who is assigned to a secure area or is responsible for this secure area the opportunity to find out more about the type, character. or the like of an emergency or event triggering an alarm before initiating any alarm or emergency measures.

In the secure area 2 assigned to the person 1, a plurality of monitoring and sensor devices 3 are provided that can be video cameras, contacts—e.g. door and/or window contacts, sound and/or motion detectors, or the like.

The monitoring and sensor devices 3 are connected to a central unit 4. The central unit 4 is assigned to the secure area 2 or to the alarm system of the secure area 2 defined by the monitoring and sensor devices 3.

The central unit 4 has a hardware key 5 that has a CPU with an access memory 6 in which a mathematical encryptor is stored and which is not readable.

Furthermore, the telecommunication system shown in the only FIGURE comprises an internet portal 7 that is hosted on a server. The internet portal 7 can be contacted by the central unit 4 in the illustrated embodiment shown via a DSL modem 8, the connection in the opposite direction also being through the DSL modem. A dedicated secure transmission channel is used to connect the internet portal 7 and the hardware key 5. A web server is assigned to the hardware key 5.

In case of an emergency or generation of an alarm signal, the person 1 assigned to the secure area 2 is automatically notified by the internet portal 7 via a communications means embodied, for example, as a cell phone 9, of the presence of a corresponding emergency or alarm signal with regard to the secure area 2. The person 1 can then establish the prerequisites likewise via this communication means, i.e., the cell phone 9, but also via a further communication means or another communication means 8 by the use of a key word or password and a corresponding return signal to the central unit 4 such that by a further communication means provided with a browser, that is, e.g., by a PC 10, access can be gained to the alarm signals recorded in the central unit 4 of the secure area 2. Before any triggering of alarm measures or emergency measures, the person assigned to the secure area 2 can thus inspect video images or other signals recorded by the monitoring and sensor devices 3 of the secure area 2, before, for example emergency measures or alarm measures are carried out or undertaken by the police.

The connection between the internet portal 7 on the one hand and the cell phone 9 or the PC 10 of the person 1 assigned to the secure area 2 on the other hand can be realized by UMTS, SMS, e-mail or by other transmission channels. The connection between the person 1 assigned to the secure area 2 via his/her communication means embodied as a cell phone 9 or communication means embodied as a PC 10 on the one hand to the internet portal 7 on the other hand can be realized by SMS, MMS, e-mail or by an internet connection.

1. (canceled)

2. The telecommunication system according to claim 8 wherein video cameras or contacts or sound or motion detectors are provided as monitoring devices or sensors connected to the central unit.

3. The telecommunication system according to claim 8 wherein the further communication means provided with a browser is a PC.

4. The telecommunication system according to claim 8 wherein the connection between the central unit provided with the hardware key and the internet portal or the communication means provided with the browser is a DSL modem.

5. The telecommunication system according to claim 8 wherein a cell phone is the communication means with the internet portal.

6. The telecommunication system according to claim 5 wherein the connection from the internet portal to the communication means of the person contacted can be by UMTS, SMS, or e-mail.

7. The telecommunication system according to claim 8 wherein the connection from the communication means of the person contacted to the internet portal can be by SMS, MMS, e-mail or by an internet connection.

8. A system for telecommunicating with an alarm system installed in a secure area, such as an apartment, a vacation or private home, an office buildings, a business premises, a bank, an insurance company, etc., comprising
a central unit that is connected to the alarm system provided in the secure area and to monitoring devices or sensors provided in or at the secure area, the alarm system having a hardware key with a CPU with an access memory in which a mathematical encryptor is stored and which cannot be read, the hardware key being contactable via the internet portal through a dedicated secure transmission channel and being assigned to a Web server,
a server connectable to the central unit,
communication means that is assigned to the person responsible for the secure area and that is contacted in the event of warning signals from the monitoring devices or sensors connected to the central unit, the server being contactable by the contacted person responsible for the secure area via a key or password, wherein
the server hosts an internet portal,
the internet portal is contacted by the central unit in the event of warning signals from the monitoring devices or sensors connected to it,
the communication means of the person assigned to the secure area is contacted by the internet portal hosted by the server, and
access can be gained to the warning signals of the monitoring and sensor devices recorded in the central unit of the alarm system assigned to the secure area using the key word or password via the internet portal via a further communications means assigned to the person contacted by the internet portal and provided with a browser.
